(19) United States
(12) Patent Application Publication
(10) Pub. No.: US 2019/0322115 A1
(43) Pub. Date: Oct. 24, 2019

(54) Sticky Note Notebook

(71) Applicant: Aldona Powers, Salt Lake City, UT (US)

(72) Inventor: Aldona Powers, Salt Lake City, UT (US)

(21) Appl. No.: 16/388,814

(22) Filed: Apr. 18, 2019

Related U.S. Application Data
(60) Provisional application No. 62/659,906, filed on Apr. 19, 2018.

(51) Int. Cl. B42D 5/00; B43K 23/00; B42B 5/00

(52) U.S. Cl. CPC B42D 5/003; B42B 5/00; B43K 23/001

(57) ABSTRACT

The sticky note notebook is a notebook characterized by pages fabricated from plastic material. The pages can hold small stacks of sticky notes and permit transfer of individual sticky notes from one plastic page to another.

### CROSS-REFERENCE TO RELATED APPLICATIONS

The present application claims priority to provisional patent application number 62/659,906, filed on Apr. 19, 2018, disclosures of which are incorporated herein at least by this reference.

### BACKGROUND OF THE INVENTION

### Field of Invention

The present invention is in the field of sticky notes. Sticky notes are small pieces of paper with re-adherable strips of glue affixed to the back of each one. Sticky notes are available in various sizes and colors, with each sticky note utilizing the same re-adherable feature. Sticky notes come in stacks, and each sticky note is attached to the subsequent one in the stack via the re-adherable glue strips.

### Description of Related Art

In the field of sticky notes, the tasks of managing and keeping track of sticky notes can be a challenge. This challenge is compounded when a user maintains a mobile lifestyle. Once the user writes on the top note of a sticky note pad, there is usually no convenient place to securely store the used sticky note, particularly if the user is not in a home or office setting. Users who maintain a mobile lifestyle may prefer to write down several notes but limit themselves to only using the top note of a sticky note pad because they do not have a convenient place to store it after detaching it from the stack.

Users who prefer writing notes by hand may find themselves using a small, non-durable paper notebook to store their sticky notes while they are away from their home or office. This storage method ultimately results in a very worn-out paper notebook that needs to be replaced frequently

Therefore, what is clearly needed is a sticky note notebook specifically designed to remedy these issues.

### BRIEF SUMMARY OF THE INVENTION

The purpose of this invention is to solve the problems mentioned above by providing a notebook with plastic pages designed for, but not limited to, the dispensing, holding, sorting, arranging and managing of sticky notes. The sticky note notebook will enable users to freely use multiple sticky notes without fear of misplacing them. It will also allow users to maintain convenient access to their notes while they are away from their homes or offices.

### BRIEF DESCRIPTION OF THE DRAWING

FIG. 1 is a visual embodiment of the present invention and depicts a top view of a sticky note notebook in an open position.

### DETAILED DESCRIPTION OF THE INVENTION

The inventor provides a unique system for dispensing, holding, sorting, arranging, and managing sticky notes. The present invention is described in detail in the following drawing, which represents one of potentially multiple embodiments of the present invention.

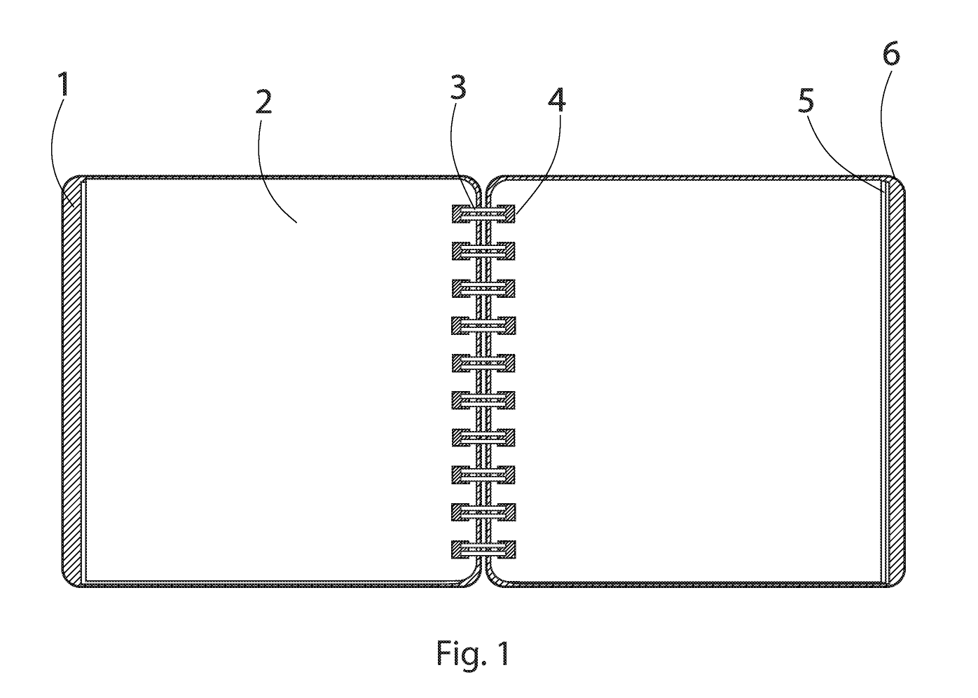

FIG. 1 is a visual embodiment of the present invention and depicts a top view of a sticky note notebook in an open position.

A sticky note notebook is constructed of pages made of durable plastic material, meaning material consisting of any of a wide range of synthetic or semi-synthetic organic compounds that are malleable and so can be molded into solid objects.

A plurality of plastic pages in a sticky note notebook provides a user with numerous pages, each designed to hold a small stack of refillable sticky notes. This design provides the user with several sticky note surfaces to write on, as used sticky notes may be easily transferred from the plastic pages. The plastic pages themselves are not designed to be written on. The different plastic pages can be used for, but not limited to, dispensing, holding, sorting, arranging, and managing sticky notes. When a plastic page is emptied of sticky notes, the user refills the plastic page with a sticky note stack, and the process is repeated.

Certain embodiments of the present invention include, but are not limited to, sticky note notebooks made in a variety of sizes. The size of a sticky note notebook depends on the size of the sticky notes a user chooses.

One embodiment of the present invention (as pictured in drawing FIG. 1), is not much larger than the standard 3×3 sticky note and is an ideal size for a user to carry around in a pocket or purse. That size of the embodiment depicted in the present invention is designed to hold a collection of plastic pages. The user can put a small stack of sticky notes on each plastic page.

Certain embodiments of the present invention include, but are not limited to, sticky note notebooks made in a variety of sizes. As an organizational tool, an embodiment of this invention in a larger size enables users to plan and aids them in keeping track of their goals. By using a sticky note notebook as an organizational tool, users can break down their goals into smaller action items that can be written on separate sticky notes. Having each step written on a separate sticky note allows users to move around, arrange, sort, prioritize, make plans for, and keep track of all their notes. In essence, the process enables users to stay organized.

In FIG. 1, which shows one embodiment of the present invention, the cover is comprised of a front cover (1) and a back cover (6). The cover, which in this preferred embodiment is rounded on all corners, can be the same height or slightly taller than the inside plastic pages; however, it is always slightly wider than the inside plastic pages, thereby preventing the inside plastic pages from extending beyond the cover (due to the curvature of the binding) when the sticky book notebook is closed.

In FIG. 1, which shows one embodiment of the present invention, the inside pages (2) are made of sturdy, yet flexible, plastic with a surface that allows self-adhesive notes to stick without dis-attaching themselves through multiple transfers. The inside plastic pages are not designed to be used as material for note-writing, but are intended to be used for the attachment of sticky notes. This purpose, however, is not limited in scope.

In FIG. 1, which shows one embodiment of the present invention, the inside plastic pages can be rounded on all 4 corners (but are only rounded on the binding edge in this preferred embodiment).

In FIG. 1, which shows one embodiment of the present invention, the sticky note notebook can be made with as many pages (5) as the binding allows, however, room should be left for users, if they choose, to affix a small stack of sticky notes on several or all pages.

In FIG. 1, which shows one embodiment of the present invention, the binding uses the 3:1 ratio Wire-O binding method (3).

In FIG. 1, which shows one embodiment of the present invention, holes (4) can be punched with a binding machine.

1. A sticky note notebook, wherein the improvement comprises: a plurality of plastic pages; a binding configured to hold the plastic pages together; and a cover attached to the binding.

2. The sticky note notebook, as set forth in claim 1 wherein the said cover is fabricated out of plastic with a surface resistant to scratching.

3. The sticky note notebook, as set forth in claim 1 wherein the said cover is fabricated out of leather, or faux leather, for a high-end look and feel.

4. The sticky note notebook, as set forth in claim 1 constructed in a convenient pocket size not much larger than the standard 3×3 sticky note, but the size of the invention may vary.

5. The sticky note notebook, as set forth in claim 1 presents a user with an opportunity to dispense, hold, sort, arrange, and manage sticky notes, enabling the user to stay organized.

6. The sticky note notebook, as set forth in claim 1 wherein said plastic pages have a waterproof surface that can be easily cleaned.

7. The sticky note notebook, as set forth in claim 1 can accommodate a wide variety of sticky notes in multiple sizes.

8. The sticky note notebook, as set forth in claim 1 further comprising a writing instrument that fits into the binding of the book, providing an available writing tool for convenience.

9. The sticky note notebook, as set forth in claim 1 constructed in a mini size that is ideal to hold 2″×2″ sticky notes. The mini size sticky note notebook can be attached to a clip mechanism that can hang from a lanyard or any other appropriate object.

10. The sticky note notebook, as set forth in claim 1 offers a user the means to conveniently use handwriting as an alternative to electronic note taking.
